(19) United States
(12) Patent Application Publication
(10) Pub. No.: US 2012/0124350 A1
(43) Pub. Date: May 17, 2012

(54) TABLE-DRIVEN SOAKER TOOL FOR INFORMATION HANDLING SYSTEMS

(75) Inventor: Meik Neubauer, Boeblingen (DE)

(73) Assignee: INTERNATIONAL BUSINESS MACHINES CORPORATION, Armonk, NY (US)

(21) Appl. No.: 12/945,756

(22) Filed: Nov. 12, 2010

(51) Int. Cl. G06F 9/30; G06F 9/38

(52) U.S. Cl. 712/241; 712/244; 712/E09.016; 712/E09.045

(57) ABSTRACT

A soaker tool for an information handling system (IHS) exercises the IHS to provide a predetermined amount of utilization that a user may specify. The soaker tool schedules wait times following respective utilization times in alternating fashion to achieve a desired utilization value for a predetermined time period. The soaker tool monitors for a dispatch interrupt during the utilization times. Should a dispatch interrupt occur during a utilization time, the soaker tool accounts for the dispatch interrupt by determining a remainder utilization time to maintain utilization accuracy. The soaker tool may employ a parameter table that specifies utilization times, wait times, loop counts and adjustment cycles indexed to the respective utilization values that a user may select. The soaker tool may employ adjustment cycles to compensate for cumulative timing errors that may occur when running the tool for extended time periods.

### BACKGROUND

The disclosures herein relate generally to information handling systems (IHSs), and more specifically, to workload generators for IHSs.

Workload managers (WLMs) play a significant role in operating systems, especially the operating systems of more complex IHSs. A workload manager controls access to system resources by the work executing on the IHS based on predetermined goals and specifications. These goals may be set by system administrators, data center operators and others.

Workload managers make decisions about resource allocation based on system utilization. Utilization refers to the percentage loading that a particular workload burdens a particular computing resource, such as a processor, processor core or other computing element. It is helpful to be able to reproduce accurate system utilization levels in a test environment to properly exercise and evaluate a particular IHS. A “soaker program” is a program that attempts to achieve a particular amount of system utilization to test a particular IHS.

### BRIEF SUMMARY

In one embodiment, a method of utilizing an information handling system (IHS) at a predetermined utilization level is disclosed. The method includes receiving, by the IHS, a selected utilization value. The method also includes fetching from a parameter table, by the IHS, a particular utilization time and a particular wait time that correspond to the selected utilization value, the parameter table including an index of utilization values and respective utilization times and wait times. The method further includes executing, by the IHS, a utilization loop of instructions that exercises the IHS according to the particular utilization time. The method still further includes monitoring, by the IHS, for a dispatch interrupt during the execution of the utilization loop. The method also includes waiting, by the IHS, the particular wait time after the IHS executes the utilization loop for the particular utilization time. In one embodiment, the method further includes exiting the utilization loop, by the IHS, if the IHS detects a dispatch interrupt during execution of the utilization loop and, in response to detecting a dispatch interrupt, reducing the utilization time by the portion of the utilization time already executed, thus providing a remainder utilization time. The method also includes re-entering, by the IHS, the utilization loop of instructions to continue exercising the IHS according to the remainder utilization time.

In another embodiment, an information handling system (IHS) is disclosed that includes a processor and a memory coupled to the processor. The memory is configured with a soaker tool that receives a selected utilization value. The soaker tool fetches from a parameter table a particular utilization time and a particular wait time that correspond to the selected utilization value, the parameter table including an index of utilization values and respective utilization times and wait times. The soaker tool also executes a utilization loop of instructions that exercises the IHS according to the particular utilization time. The soaker tool also monitors for a dispatch interrupt during the execution of the utilization loop. The soaker tool waits during the particular wait time after the IHS executes the utilization loop for the particular utilization time. In one embodiment, the soaker tool exits the utilization loop if during the monitoring the IHS detects a dispatch interrupt while executing the utilization loop. In response to detecting a dispatch interrupt, the IHS reduces the utilization time by the portion of the utilization time already executed, thus providing a remainder utilization time. The IHS re-enters the utilization loop of instructions to continue exercising the IHS according to the remainder utilization time.

In yet another embodiment, a soaker tool computer program product is disclosed that includes a computer readable storage medium. The soaker tool computer program product includes first program instructions that receive a selected utilization value. The soaker tool also includes second program instructions that fetch from a parameter table a particular utilization time and a particular wait time that correspond to the selected utilization value, the parameter table including an index of utilization values and respective utilization times and wait times. The soaker tool further includes third program instructions that execute a utilization loop of instructions that exercises the IHS according to the particular utilization time. The soaker tool also includes fourth program instructions that monitor for a dispatch interrupt during the execution of the utilization loop. The soaker tool further includes fifth program instructions that wait the particular wait time after the IHS executes the utilization loop for the particular utilization time. In one embodiment, the soaker tool includes sixth program instructions that exit the utilization loop if the IHS detects a dispatch interrupt during execution of the utilization loop and, in response to detecting a dispatch interrupt, reduces the utilization time by the portion of the utilization time already executed, thus providing a remainder utilization time. The soaker tool also includes seventh program instructions that re-enter the utilization loop of instructions to continue exercising the IHS according to the remainder utilization time.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 is a block diagram of one embodiment of the disclosed information handling system with soaker tool.

FIG. 2 is a block diagram showing the soaker tool in the memory of the disclosed IHS.

FIGS. 3A-3D together form a parameter table that the soaker tool may employ.

FIG. 4A-4C together form a flowchart of process flow in the disclosed soaker methodology.

### DETAILED DESCRIPTION

The disclosed workload generator or soaker methodology provides a particular system utilization that a user specifies for an information handling system (IHS) of interest. The IHS may include a workload manager (WLM) that controls access to system resources for the workload executing on the IHS.

It is difficult to create a workload generator or soaker program tool that accurately provides a predetermined level of utilization for an IHS. In other words, if a programmer writes a soaker tool intended to provide a 20% utilization (i.e. a 20% utilization value for the IHS), it is likely that the actual utilization will be somewhat higher or somewhat lower than the target 20% utilization. Moreover, soaker tools are typically not additive or cumulative. For example, if a programmer writes a soaker tool to provide 20% utilization and a particular IHS executes two instances of this soaker tool, then the total cumulative utilization will likely not be precisely 40%, but rather some lower utilization value. It has been found to be it difficult to create a soaker tool with accurate predetermined utilization that does not employ manual adjustment or tuning to reach the desired utilization level. Furthermore, such manual adjustment or tuning typically depends on utilization reports based on the IHS's measurement of utilization. This situation creates a dependency on the exactness of such IHS measurements, which is challenging because of difficulty in determining the accuracy of the IHS measurement itself. In the following discussion, the variable ut(p) refers to the percentage utilization or utilization value of the IHS expressed in percentage of utilization.

In one embodiment, the disclosed soaker methodology employs a triple-nested loop including an inner loop that establishes a predetermined utilization time that a user may select. The inner loop, namely a utilization loop, includes a number of instructions that execute repetitively to consume execution unit resources for the duration of the utilization time. Execution unit resources may also be referred to as central processing unit (CPU) resources. The inner loop nests within a middle loop, namely a scheduling loop, that establishes a wait time following each utilization time of the inner loop. The inner loop exercises the IHS by consuming CPU resources during the utilization time and then exits to the middle loop that waits a predetermined wait time without consuming CPU resources after each utilization time. The number of times that the middle loop executes is specified by a loop count such that the execution time adds up to a so-called “quantum time”. The quantum time corresponds to the resolution of the soaker methodology, namely the shortest time period for which the methodology may provide a predetermined utilization value, ut (%). The utilization time, ut (mS), and the wait time, wt (mS), together determine the utilization value or utilization percentage, ut (%), as per Equation 1 below.

ut(%)=[ut/(ut+wt)]×100 Equation 1

The designation “mS” represents time in milliseconds. The middle loop and inner loop both nest within an outer loop that controls the overall runtime during which the soaker tool provides the desired utilization. The overall runtime is a multiple of quantum times.

The disclosed soaker methodology may employ multiple tables to provide the soaker with parameters to enable the soaker to provide a specified percentage utilization, ut (%). For example, the soaker methodology may employ a utilization time table, a wait time table, a loop counter table, and an adjustment table to provide timing corrections, as discussed in more detail below.

In one embodiment, the disclosed soaker methodology addresses the situation wherein a dispatch interrupt occurs while the inner loop is running to establish the utilization time. More particularly, if a dispatch interrupt occurs while the inner loop is running, then the inner loop exits and the dispatcher immediately reschedules the inner loop, but with a utilization time reduced by the amount of the confirmed dispatch time. This action prevents inaccuracies that the dispatch interrupt might otherwise introduce in the soaker methodology. In some operating scenarios, it is possible that the amount of time that the middle loop and inner loop run may not exactly equal a quantum time. When this occurs, the methodology may provide adjustment loops via an outer loop to compensate for such inaccuracies, as described in more detail below. In this manner, the disclosed soaker methodology may achieve a highly accurate user-specified utilization without manual tuning. The methodology may also provide a utilization level that is cumulative for multiple instances of the soaker tool.

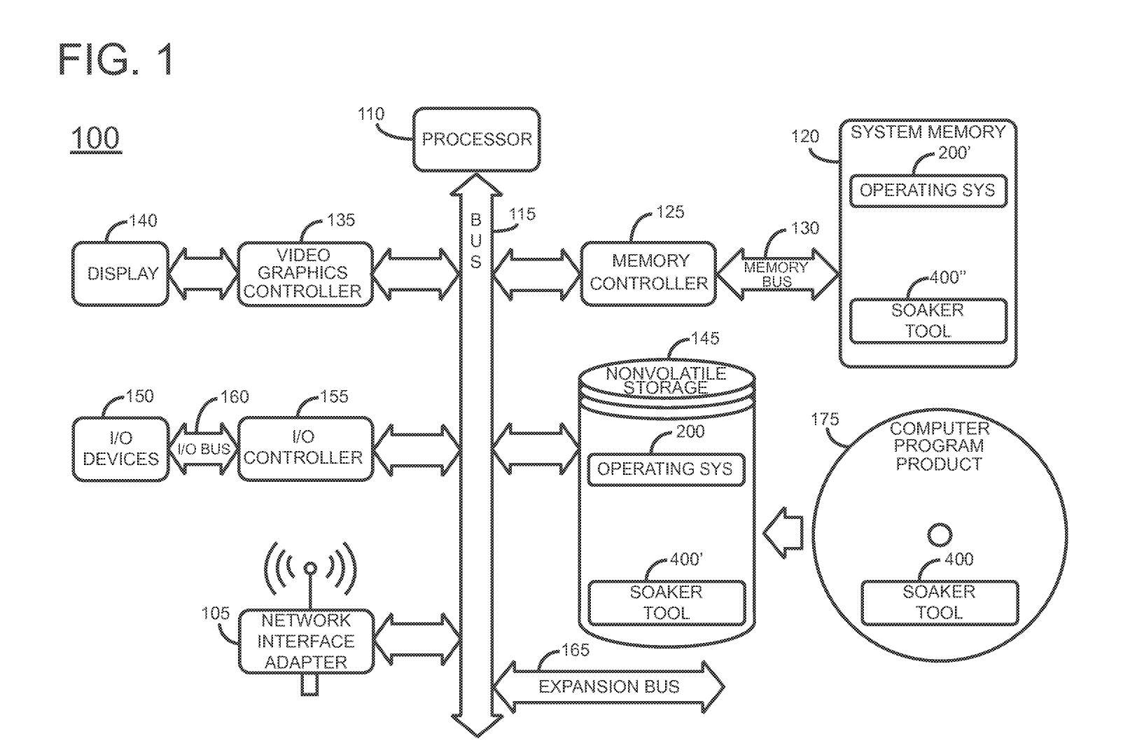

FIG. 1 is a block diagram of an information handling system (IHS) 100 that employs the disclosed soaker methodology to provide the IHS with a workload exhibiting a predetermined utilization. IHS 100 includes a processor 110 that may include multiple cores. IHS 100 processes, transfers, communicates, modifies, stores or otherwise handles information in digital form, analog form or other form. IHS 100 includes a bus 115 that couples processor 110 to system memory 120 via a memory controller 125 and memory bus 130. In one embodiment, system memory 120 is external to processor 110. System memory 120 may be a static random access memory (SRAM) array or a dynamic random access memory (DRAM) array. Processor 110 may also include local memory (not shown) such as L1 and L2 caches (not shown). A video graphics controller 135 couples display 140 to bus 115. Nonvolatile storage 145, such as a hard disk drive, CD drive, DVD drive, or other nonvolatile storage couples to bus 115 to provide IHS 100 with permanent storage of information. Nonvolatile storage 145 stores an operating system 200 (OPERATING SYS) that governs operation of IHS 100. I/O devices 150, such as a keyboard and a pointing device, couple to bus 115 via I/O controller 155 and I/O bus 160.

One or more expansion busses 165, such as USB, IEEE 1394 bus, ATA, SATA, PCI, PCIE, DVI, HDMI and other busses, couple to bus 115 to facilitate the connection of peripherals and devices to IHS 100. A network interface adapter 105 couples to bus 115 to enable IHS 100 to connect by wire or wirelessly to a network and other information handling systems. Network interface adapter 105 may also be called a network communication adapter or a network adapter. While FIG. 1 shows one IHS that employs processor 110, the IHS may take many forms. For example, IHS 100 may take the form of a desktop, server, portable, laptop, notebook, tablet, or other form factor computer or data processing system. IHS 100 may take other form factors such as a gaming device, a personal digital assistant (PDA), a portable telephone device, a communication device or other devices that include a processor and memory.

IHS 100 includes a soaker tool computer program product 400 on digital media 175 such as a CD, DVD or other media. In practice, IHS 100 may store operating system 200 (OPERATING SYS) and soaker tool 400 on nonvolatile storage 145 as operating system 200 and soaker tool 400′. When IHS 100 initializes, the IHS loads operating system 200 into system memory 120 for execution as operating system 200′. IHS 100 also loads soaker tool 400′ into system memory 120 for execution as soaker tool 400″.

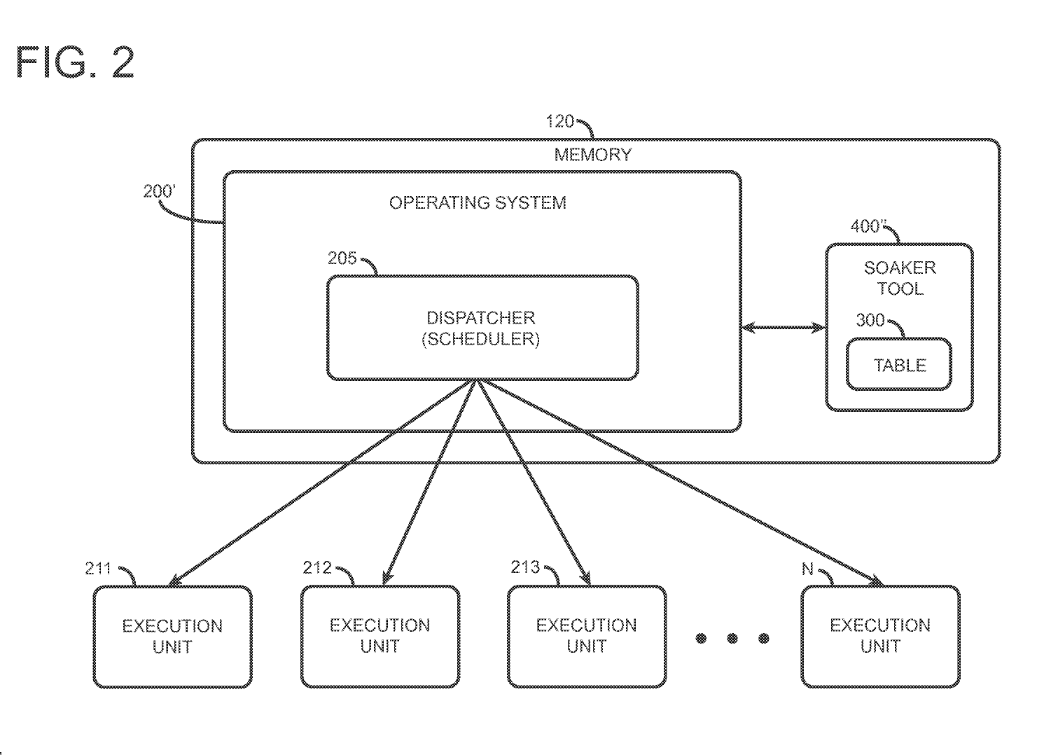

FIG. 2 is a block diagram representation of a portion of IHS 100 showing multi-tasking operating system 200′ and soaker tool 400″ loaded in memory 120 for execution. Operating system 200′ includes a dispatcher 205, also referred to as a scheduler, that assigns time slices to the programs or applications that IHS 100 executes. Dispatcher 205 distributes the multiple programs executing on IHS 100 across the available execution units to assure that each program receives an allocation for an amount of time, or time slice, in which to execute. For example, dispatcher 205 may assign a 20 mS time slice to a first program, interrupt execution of the first program with a dispatch interrupt, assign another 20 mS time slice to a second program, interrupt execution of the second program with a dispatch interrupt, assign another 20 mS time slice to a third program, and so forth. The time duration of each time slice may exhibit a value other than this 20 mS example, which is used for illustration purposes and should not be taken as limiting. Dispatcher 205 assigns the task of executing programs during these time slices to appropriate execution units such as execution units 211, 212, 213, . . . N, wherein N is the total number of execution units. Execution units 211, 212, 213, . . . N may be processors, processor cores or functional units such as integer and floating point execution units.

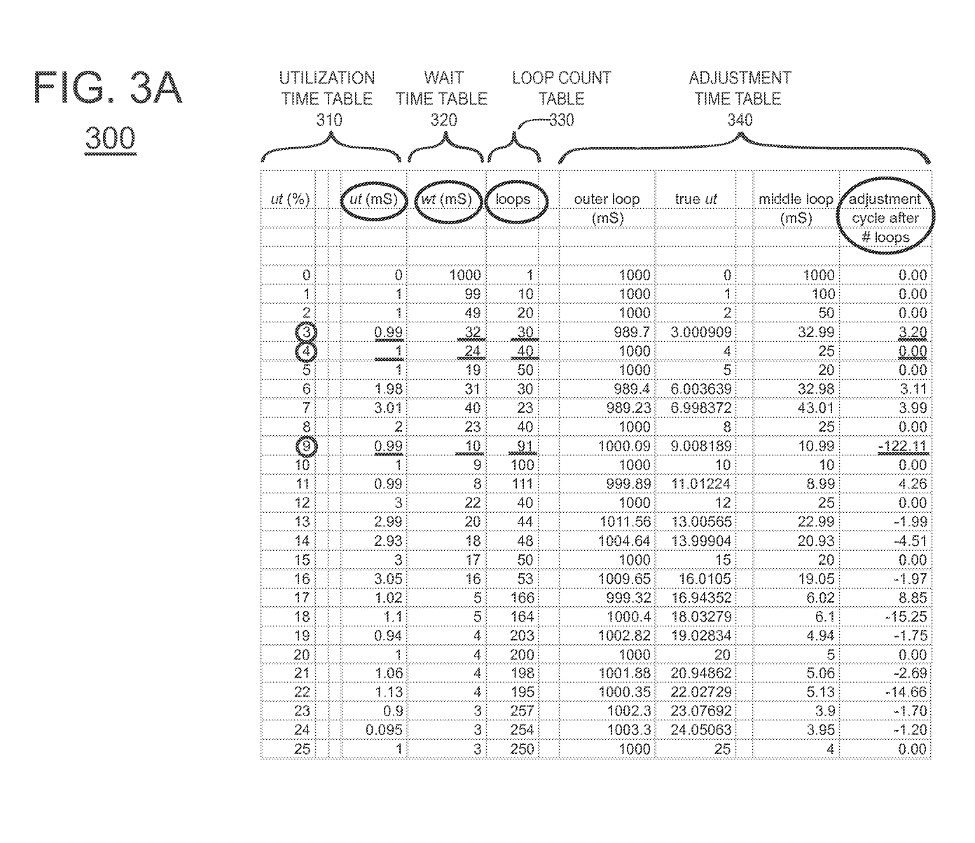

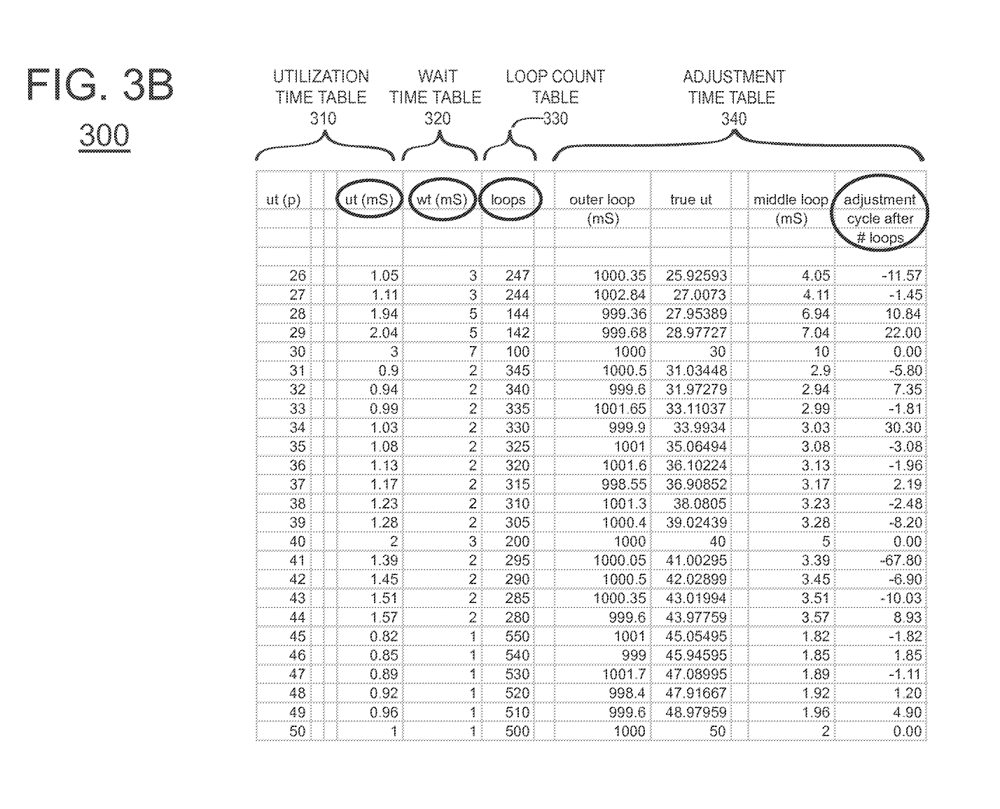

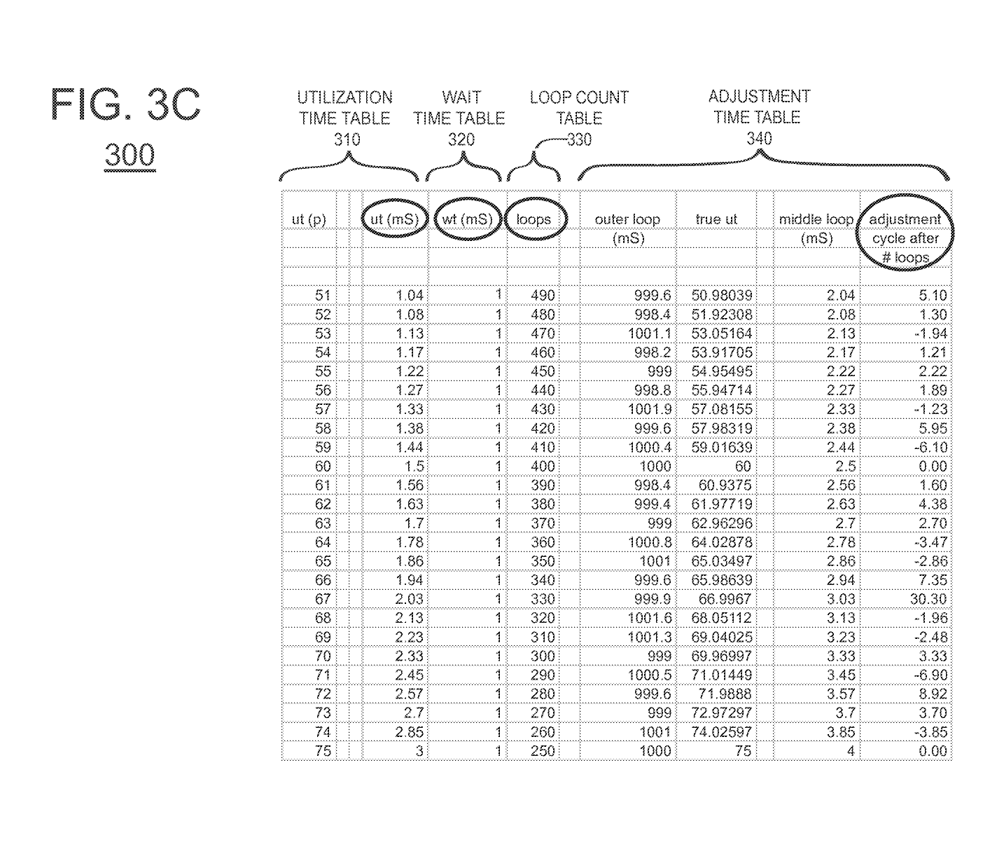

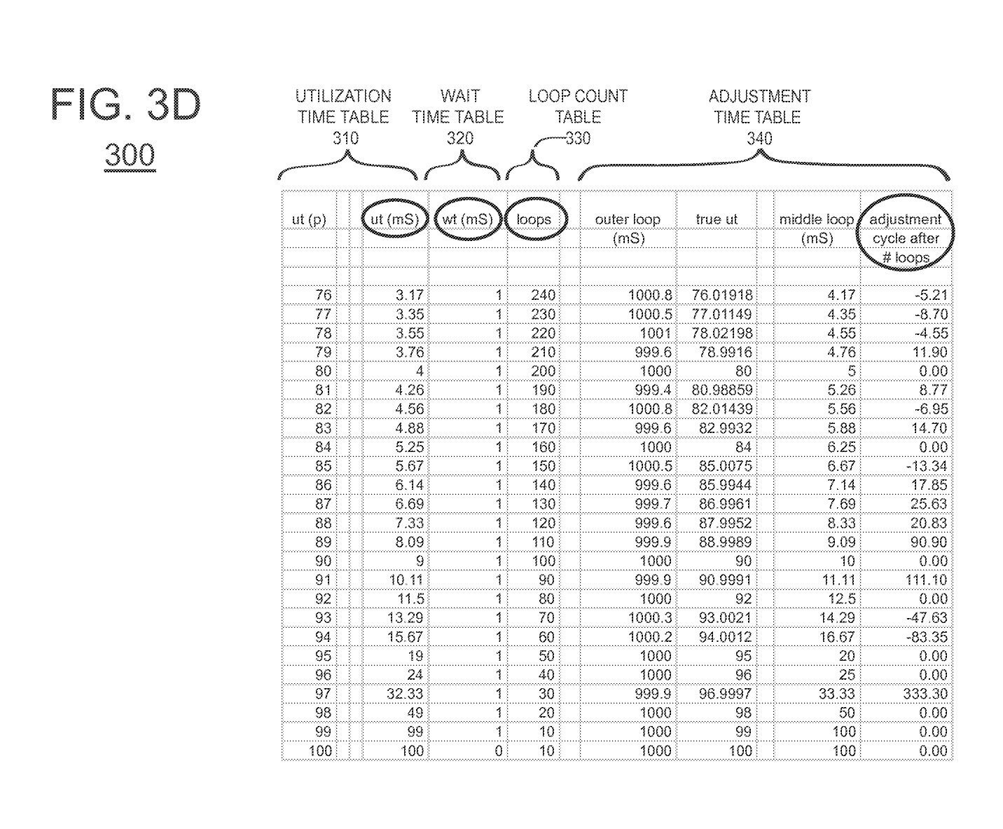

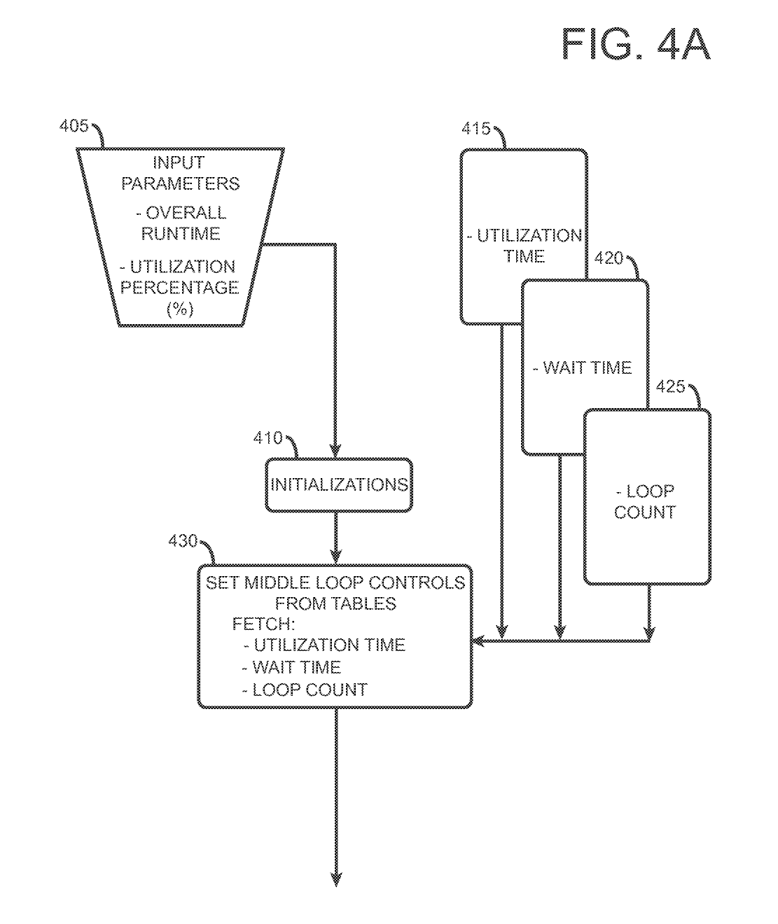

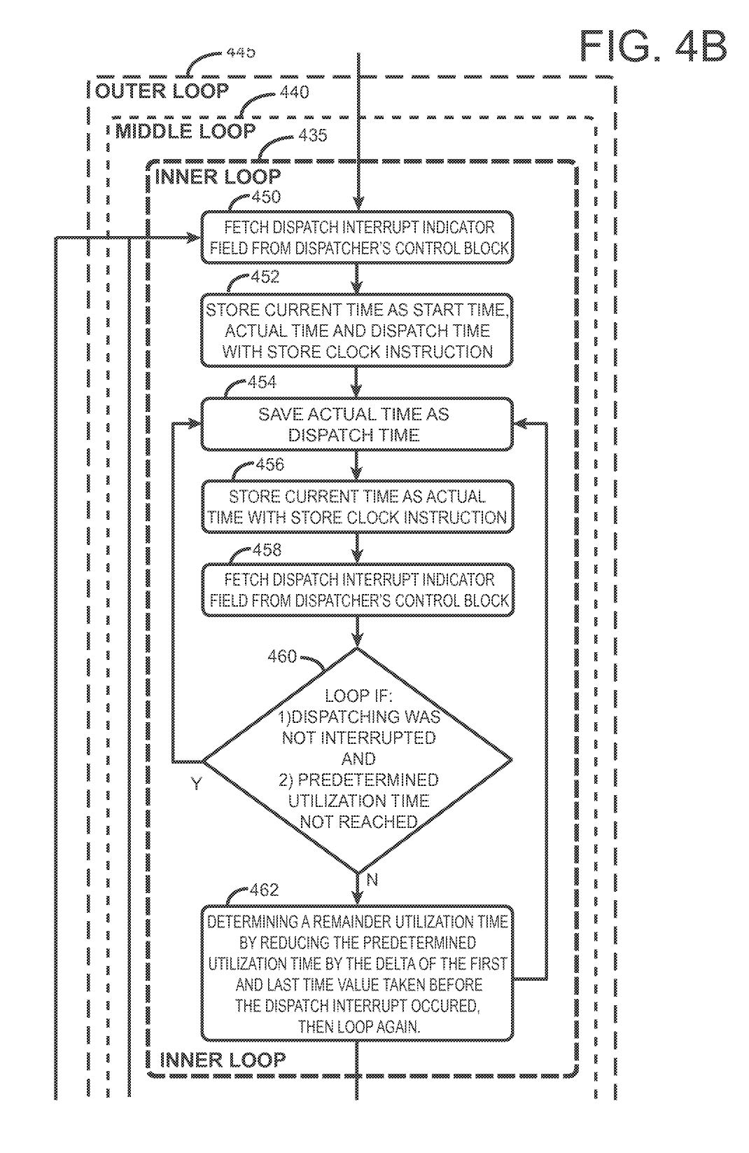

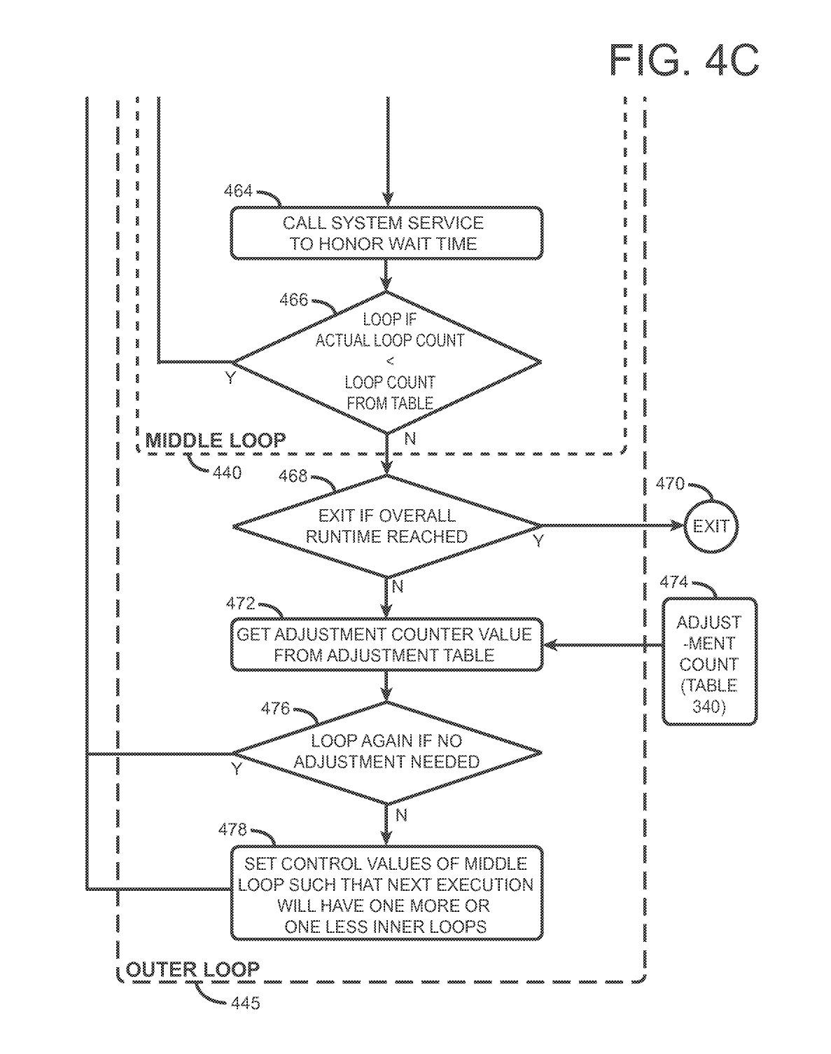

FIGS. 3A-3D show a parameter table 300 that includes a utilization time table 310, a wait time table 320, a loop count table 330 and an adjustment time table 340. In one embodiment, soaker tool 400 includes parameter table 300. In another embodiment, parameter table 300 is external to soaker tool 400″ but accessible by soaker tool 400″. Parameter table 300 provides predetermined parameters that enable soaker tool 400″ to provide a workload with a utilization percentage selected by a user or other entity. The use of the parameters of parameter table 300 in the disclosed methodology is discussed in more detail with reference to the flowchart of FIGS. 4A-4C below. It should be noted however that, in one embodiment, the disclosed methodology is table-driven, namely driven by the parameters of table 300.

In utilization time table 310, ut(%) is the utilization percentage or utilization value that the user selects and provides to soaker tool 400 as input. This is the utilization percentage that the user desires IHS 200 to experience. Utilization table 310 includes a respective utilization time, ut(mS) for each selectable utilization percentage ut(%). The parameters of utilization table 310 relate to execution of the inner loop, namely establishment of the utilization time portion of each quantum time that the second loop controls.

In wait time table 320, wt (mS) is the wait time in milliseconds. Wait time table 320 includes a respective wait time, wt, for each utilization time, ut, and utilization value, ut (%), of utilization table 310. The middle loop runs multiple inner loops to generate utilization times ut and injects a wait time wt after each utilization time ut of the inner loop in alternating fashion. The middle loop runs for a number of middle loops that approximates a quantum time. Loop count table 330 includes a value for “loop count” namely the number of middle loops needed to establish the predetermined utilization percentage for a quantum time period of approximately 1 second, in this particular embodiment. Quantum times less than or greater than 1 second may be used as well depending on the particular application and time resolution desired.

In adjustment time table 340, !outer loop (mS)! refers to the total runtime in milliseconds that the outer loop operates the inner and middle loops of soaker tool 400 at the predetermined utilization percentage. “True ut” is the true utilization that soaker tool 400 exhibits. !Middle loop (mS)! is the amount of time that one middle loop actually consumes, namely the utilization time of all inner loops plus all wait times scheduled in the middle loop. In adjustment time table 340, “adjustment cycle after # loops” is the calculative number of middle loops after which the cumulative time deviation equals one middle loop.

FIGS. 4A-4C together form a flowchart that depicts process flow in one embodiment of the disclosed soaker methodology. The portion of the flowchart shown in FIG. 4A describes the input of parameters that a user or other entity provides. For example, the user may select the overall runtime desired for soaker tool 400 to execute on IHS 100, as per block 405. The user may also select the utilization percentage or utilization value for soaker tool 400 to exercise IHS 100, as per block 405. Soaker tool 400 initializes values, as per block 410. Depending on the particular overall runtime and utilization percentage ut (%) that the user selects, soaker tool 400 fetches corresponding values of utilization time ut, wait time wt and loop count from table 300, as per block 430. More particularly, soaker tool retrieves utilization time ut as per block 415, wait time wt as per block 420 and loop count as per block 425. In this manner, the disclosed methodology is table-driven with information from table 300 of FIGS. 3A-3D. By fetching parameters from table 300, soaker tool 400 sets middle loop controls according to the fetched utilization time, wait time and loop count, as per block 430. In this manner, table 300 provides initialization values to soaker tool 400.

FIG. 4B is a continuation of the flowchart that FIG. 4A depicts. After the initialization and parameter fetching operations of FIG. 4A, IHS 100 executes inner loop 435 of FIG. 4B. At a high level, one function of inner loop 435 is to establish the utilization time ut. Inner loop 435 includes a number of instructions that loop back on themselves to consume CPU computing resources to establish the utilization time. While inner loop 435 loops in this manner, dispatcher 205 may generate a dispatch interrupt to indicate the end of a particular time slice that dispatcher 205 assigned to soaker tool 400. In one embodiment, inner loop 435 constantly checks to determine if it received a dispatch interrupt. Inner loop 435 also constantly checks to see if the utilization time ut transpired. If inner loop 435 determines that the utilization time ut transpired, then inner loop 435 falls back to a middle loop 440. Middle loop 440 provides a wait time wt that follows each utilization time ut. By generating utilization times ut and wait times wt in alternating fashion, inner loop 435 and middle loop 440 together closely approximate the specified utilization percentage ut (%), as discussed in more detail below. Outer loop 445 acts as a master control loop that determines the total runtime of soaker tool 400.

As discussed above at a high level, while looping inner loop 435 monitors to determine if and when inner loop 435 receives a dispatch interrupt. In response to receiving such a dispatch interrupt, inner loop 435 provides the total time that loop 435 has been running since it started running for the current time slice. This total time is the actually achieved utilization time up to the current time. However, after a dispatch interrupt occurs and before falling back to the middle loop 440, inner loop 435 reduces the predetermined utilization time by the actually achieved utilization time to generate a remainder utilization time. Inner loop 435 then runs again until the remainder utilization time is achieved or another dispatch interrupt occurs.

In more detail, referring again to the flowchart portion of FIG. 4B, inner loop 435 of soaker tool 400 commences with fetching a dispatch interrupt indicator field from the dispatcher 205, as per block 450. This dispatch interrupt indicator field, by virtue of its contents changing, indicates the occurrence of a dispatch interrupt. Soaker tool 400 stores the “current time” as “start time”, “actual time” and “dispatch time” by using a Store Clock instruction, or equivalent, as per block 452. In one embodiment, to provide equal values for these three time values of “start time”, “actual time” and “dispatch time”, IHS 100 executes the Store Clock instruction once and copies the same returned “current time” value to “start time”, “actual time” and “dispatch time”. The Store Clock instruction essentially provides the time of day at the time of calling the Store Clock function. Soaker tool 400 saves the actual time as dispatch time, as per block 454. Soaker tool 400 stores the current time as actual time by using the Store Clock instruction, as per block 456. Soaker tool 400 fetches the dispatch interrupt indicator field from dispatcher 205, as per block 458. This informs inner loop 435 with respect to whether or not a dispatch interrupt occurred. By executing the functions of block 450, 452, 454, 456 and 458, inner loop 435 consumes CPU resources, thus utilizing processor 110 and IHS 100 and establishing utilization time. The repetitive execution of these blocks within inner loop 435 provides utilization of processor 110.

Soaker tool 400 conducts a test at test block 460 to determine if both of the following conditions are true, namely 1) a dispatch interrupt did not occur, and 2) that the inner loop 435 did not yet reach the predetermined utilization time ut. If test block 460 determines that neither a dispatch interrupt occurred nor the predetermined utilization time was reached, then process flow continues back to block 454 and the inner loop continues executing and looping. If a dispatch interrupt occurred and the predetermined utilization time was not reached, then block 462 reduces the predetermined utilization time ut by the difference or delta between the first and last time value taken before the dispatch interrupt occurred. In other words, this delta represents the difference between the start time of block 452 and the dispatch time of block 454. Reducing the predetermined utilization time ut in this manner results in a remainder utilization time for which the inner loop should still execute to achieve the specified utilization. To do so, process flow continues from block 462 back to “save actual time as dispatch time” block 454, as shown in FIG. 4B. However, if inner loop 435 reached the predetermined utilization time, then there is no remainder utilization time and inner loop 435 exits or falls back to middle loop 440 via block 462.

After exiting inner loop 435 and entering middle loop 440 shown in FIG. 4C, middle loop 440 calls a system service to wait for the wait time wt previously fetched in block 430. In this manner, a predetermine wait time follows each utilization time to form the overall percentage utilization when combined. During a wait time, processor 100 halts processing activities of the execution units such that processor 110 waits. In other words, utilization of processor 110 substantially ceases during wait times. At decision block 466, middle loop 440 conducts a test to determine if the actual number of middle loops executed thus far is less than the loop count fetched from loop count table 330 at block 430. The fetched loop count corresponds to the number of middle loops required to run in order to provide the specified utilization for a predetermined time period, defined as the quantum time. In one embodiment, the quantum time is one second, for example. Other values of quantum time may be employed depending on the particular application. In this embodiment, the middle loop 435 runs for one quantum time. The actual loop count is the number of middle loops currently executed at a particular point in time. At decision block 466, if the actual loop count is less than the loop count from table 330, then process flow continues back to block 450 and the middle loop continues executing inner loops 435 to establish utilization times followed by respective wait times, thus providing the overall utilization percentage specified. When decision block 466 determines that the actual loop count is no longer less than the loop count from table 330, this signifies that middle loop 435 has reached quantum time, and in response, middle loop 435 passes process flow to outer loop 445.

More particularly, when middle loop 440 reaches quantum time, process flow passes to outer loop 445 which performs a test to determine if soaker program 400 reached the overall predetermined runtime, as per decision block 468. The outer loop 445 controls the overall runtime as a multiple of successive middle loops 440 wherein each middle loop runs for one quantum time. Assuming that quantum time is 1 second and the desired overall runtime is 5 seconds, then outer loop 445 schedules 5 middle loops to achieve the predetermined utilization percentage for a total of 5 seconds. Outer loop 445 also performs adjustment loops to compensative for cumulative timing errors, as described in more detail below.

In actual practice, middle loop 440 approximates the specified quantum time, but may not always exactly equal the quantum time. In other words, assume that the middle loop comes close to quantum time, but in all cases a middle loop may not end exactly at the quantum time. The difference between quantum time and the time at which the middle loop actually ends may be positive or negative and is typically very small because the inner loop is very small in terms of lines of code and execution duration. An adjustment loop feature accounts for and corrects these deviations as described below.

When middle loop 440 exits, outer loop 445 checks to determine if soaker tool 400 reached the overall runtime, at decision block 468. If soaker tool 400 already reached the overall runtime, then the soaker tool exits at exit block 470 and soaker tool process flow terminates. However, if soaker tool 400 did not yet reach the overall runtime, then processing continues and outer loop 445 fetches an adjustment counter value from adjustment time table 340, as per block 472 and block 474. At decision block 476, if no adjustment is needed, then process flow continues back to block 450 and another middle loop executes. Otherwise, outer loop 445 executes middle loop 440 in a manner such that execution of middle loop 440 will include one more or one less inner loop depending on the direction of the time adjustment needed to compensate for the middle loop not equaling one quantum time, as per block 478. Process flow then continues back to block 450 and the middle loop executes again with the adjustment described.

Since the “adjustment cycle after # loops” value typically is fractional, the adjusted runtime still does not exactly meet the user-specified overall runtime—although for typical usage it is sufficiently close. Enhanced precision can be achieved by implementing a second level adjustment table and second level adjustment logic in the outer loop. Furthermore, this can be repeated up to an nth-level adjustment such that the runtime precision can be increased to an arbitrary degree.

Referring now to table 300 of FIG. 3A, the following example illustrates the operation of inner loop 435, middle loop 440 and outer loop 445 in a scenario wherein outer loop 445 does not need to impose an adjustment. For convenience, relevant information in table 300 of FIG. 3A is circled or underlined to make reference easier. In this particular example, the user desires that soaker tool 400 exhibit a utilization percentage of 4%. To indicate this selection, the user inputs the selected utilization percentage value 4% into soaker tool 400. As noted above, table 300 is indexed by utilization percentage, ut(%). In other words, wait time table 320, loop count table 330 and adjustment timetable 340 include respective parameters indexed to particular utilization percentage values in utilization time table 310 within table 300.

After receiving the 4% utilization value input by the user, soaker tool 400 fetches the corresponding respective 1 mS utilization time ut from utilization time table 310 and also fetches the respective 24 mS wait time wt from wait time table 320. Soaker tool 400 also fetches the corresponding middle loop count (40 middle loops) from loop count table 330. In response to receiving these parameters, soaker tool 400 executes inner loop 435 for 1 mS to establish the utilization time. Soaker tool 400 executes middle loop 440 to establish a 24 mS wait time after each 1 mS utilization time. One middle loop thus consumes 25 mS, namely a 1 mS utilization time followed by a 24 mS wait time. The middle loop count from table 330 for a 4% utilization is 40 loops. Soaker tool 400 thus executes the middle loop 40 times to achieve a 1000 mS or 1 second quantum time, as per decision block 466 of middle loop 440 of FIG. 4C. The outer loop 445 schedules as many middle loops 440 as necessary to reach a predetermined runtime that the user may input to soaker tool 400. In this particular example, the outer loop 445 need not perform any adjustment cycles as indicated by the zero (0.00) that soaker tool 400 fetches from adjustment time table 340 for the table entry corresponding to a 4% utilization.

The following alternative example illustrates the operation of inner loop 435, middle loop 440 and outer loop 445 in a scenario wherein outer loop 445 performs an adjustment. In this particular example, the user desires that soaker tool 400 exhibit a utilization percentage of 3%. To indicate this selection, the user inputs the selected value 3% into soaker tool 400. After receiving the 3% utilization value input by the user, soaker tool 400 fetches the corresponding respective 0.99 mS utilization time ut from utilization time table 310 and the respective 32 mS wait time wt from wait time table 320. Soaker tool 400 also fetches the corresponding middle loop count (30 middle loops) from loop count table 330. In response to receiving these parameters, soaker tool 400 executes inner loop 435 for 0.99 mS to establish the utilization time. Soaker tool 400 executes middle loop 435 to establish a 32 mS wait time after each 0.99 mS utilization time. One middle loop thus consumes 32.99 mS, namely a 0.99 mS utilization time plus a 32 mS wait time. Executing the middle loop 30 times consumes 989.7 mS, namely 32.99 mS×30 loops. This 989.7 mS time for executing the middle loop for the 30 time loop count does not exactly equal the 1 sec quantum time, and thus after outer loop 445 calls middle loop 440 for a relatively long amount of time, timing error will accumulate. In this event, outer loop 445 performs an adjustment or correction by adding or subtracting an inner loop when middle loop 440 next calls inner loop 435.

In more detail, outer loop 445 performs an adjustment as follows. Since the “adjustment cycle after # loops” value from adjustment table 340 is a positive value, namely +3.2, for a 3% utilization, soaker tool 400 rounds 3.2 down to the nearest integer, namely 3. In one embodiment, the “adjustment cycle after # loops” values of adjustment time table 340 may be built so that no rounding is necessary by including already rounded values. After soaker tool 400 executes 3 middle loops and the next middle loop is about to be executed, soaker tool 400 adds one more loop to the 30 loops that soaker tool 400 would otherwise execute. In other words, the loop count of the middle loop is now 31 instead of 30, such that the middle loop executes the inner loop one more time to achieve adjustment.

In contrast with the positive adjustment scenario described above, in a scenario wherein the adjustment cycle that adjustment tables 340 specifies is negative, soaker tool 400 subtracts one loop from the loop count of the middle loop so that soaker tool 400 executes one less inner loop than it otherwise would. For example, if the user inputs a 9% desired utilization value to soaker tool 400, soaker tool 400 fetches the corresponding 0.99 mS utilization time, 10 mS wait time, 91 middle loop count and −122.11 “adjustment cycle after # loops” value from table 300. The negative “adjustment cycle after # loops” value signifies that after 122 times of executing the middle loop, the next time the outer loop calls the middle loop, it calls the middle loop with a loop count of 90 instead of 91. In other words, soaker tool 400 subtracts one loop from the loop count of 91 such that soaker tool 400 executes one less inner loop than it otherwise would. Soaker tool 400 thus reschedules the middle loop one time with an altered loop count parameter to compensate for accumulated time inaccuracies. In this manner, soaker tool 400 achieves adjustment or correction of the utilization over time to assure accuracy.

The following provides additional information relating to the generation of table 300 that provides parameters to the table-driven logic that the flowchart of FIGS. 4A-4C represents. The leftmost column of utilization table 310 shows the user-specifiable utilization ut (%). The next column ut of utilization table 310 represents the utilization time. The next column wt represents the wait time in table 320. The next column entitled “loops” represents the number of middle loops in a quantum time in loop count table 330. The resolution of 1/100 mS is much higher than a typical CPU clock resolution, but in this particular embodiment there is no need for more precision, because the true limitation is determined by the lower bound of 1 mS for the wait time. The number of middle loops is chosen such that one outer loop comes as close as possible to the quantum time which is 1000 mS or 1 second in this particular embodiment. The values for utilization time ut and wait time wt, when executed, will create a utilization that is close to the intended utilization, but does not exactly match the intended utilization in all cases. The true utilization, true ut, can be determined according to Equation 2:

true utilization (true ut)=[ut/(wt+ut)]×100 Equation 2

Table 300 of FIG. 3A shows true utilization (true ut) as part of adjustment time table 340. The deviation from the intended nominal utilization is typically below 0.05%. This is sufficient for any practical application. The outer loop is assumed to run for quantum time. However, in all cases this does not exactly match the construction parameters of the middle and inner loops. Since this is a permanent deviation, the deviation accumulates over time and thus will either reduce or extend the overall running time by considerable amounts. To minimize this effect, the disclosed methodology employs the adjustment cycles discussed above. In an adjustment cycle, the soaker tool adjusts the loop count by +/−1 loop. An adjustment cycle is indicated when the accumulated outer loop deviation from quantum time is not less than the running time of one middle loop. The following value: (middle loop runtime)/(quantum time−outer loop runtime), rounded to the closest integer, represents the number of outer loops to be run before the soaker tool executes an adjustment cycle. Adjustment time table 340 shows this value as “adjustment cycle after # loops”. A negative value indicates a reduction of one inner loop whereas, a positive value indicates an additional inner loop.

In summary, the disclosed soaker methodology provides a general approach for generating a reference workload independent of a specific operating system or hardware. The disclosed soaker methodology may work independently of other tools in the information handling system, while providing reliable utilization and additive or cumulative behavior. A preferred embodiment of the soaker methodology employs three nested loops, namely inner loop 435, middle loop 440 and outer loop 445. This is achieved by implementing three nested loops. Each loop includes dedicated steering logic and exit conditions, as defined in the flowchart of FIGS. 4A-4C. Inner loop 435 is a utilization loop that represents the core CPU consumption unit. Inner loop 435 measures actual dispatch time by actual time flow by using the Store Clock instruction. More specifically, inner loop 435 detects dispatch interrupts by continuous examination of dispatcher controls associated with dispatcher 205. A typical control that can be used is the “official” dispatch time field that dispatcher 205 updates with each dispatch interrupt. The middle loop 440 is a scheduling loop that grants wait times after the inner loop 435 finishes. The relation of inner loop utilization time and wait time represents the utilization percentage that the user specified. Both utilization time and wait time should be as small as possible to avoid that the soaker task being swapped out by dispatcher 205 due to inactivity. The outer loop 445 is a master control loop that controls the overall running time as a multiple of successive middle loops scheduled for quantum time. The outer loop 445 also controls adjustment loops to perform time compensation in the manner discussed above to correct for cumulative timing error.

As will be appreciated by one skilled in the art, aspects of the disclosed soaker methodology may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the FIGS. 4A-4C flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts of FIGS. 4A-4C and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowcharts of FIGS. 4A-4C described above.

The flowcharts of FIGS. 4A-4C illustrate the architecture, functionality, and operation of possible implementations of systems, methods and computer program products that perform network analysis in accordance with various embodiments of the present invention. In this regard, each block in the flowcharts of FIGS. 4A-4C may represent a module, segment, or portion of code, which comprises one or more executable instructions for implementing the specified logical function(s). It should also be noted that, in some alternative implementations, the functions noted in the block may occur out of the order noted in FIGS. 4A-4C. For example, two blocks shown in succession may, in fact, be executed substantially concurrently, or the blocks may sometimes be executed in the reverse order, depending upon the functionality involved. It will also be noted that each block of FIGS. 4A-4C and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of utilizing an information handling system (IHS), the method comprising:
receiving, by the IHS, a selected utilization value;
fetching from a parameter table, by the IHS, a particular utilization time and a particular wait time that correspond to the selected utilization value, the parameter table including an index of utilization values and respective utilization times and wait times;
executing, by the IHS, a utilization loop of instructions that exercises the IHS according to the particular utilization time;
monitoring, by the IHS, for a dispatch interrupt during the execution of the utilization loop; and
waiting, by the IHS, the particular wait time after the IHS executes the utilization loop for the particular utilization time.

2. The method of claim 1, further comprising:
exiting the utilization loop, by the IHS, if while monitoring the IHS detects a dispatch interrupt during execution of the utilization loop and, in response to detecting a dispatch interrupt, reducing the utilization time by the portion of the utilization time already executed thus providing a remainder utilization time; and
re-entering, by the IHS, the utilization loop of instructions to continue exercising the IHS according to the remainder utilization time.

3. The method of claim 2, further comprising:
scheduling, by the IHS, a number of utilization loops of instructions and respective wait times to consume an amount of time equal to a predetermined quantum time.

4. The method of claim 3, wherein the scheduling of a number of utilization loops of instructions and respective wait times is performed by a scheduling loop of instructions.

5. The method of claim 2, wherein the portion of the utilization time already executed is determined by the IHS determining the difference between a loop execution start time when the IHS starts to execute the utilization loop of instructions and a dispatch time when the IHS interrupts execution of the utilization loop of instructions.

6. The method of claim 4, further comprising:
fetching, by the IHS, from the parameter table a loop count corresponding to the utilization value; and
executing, by a master control loop in the IHS, the scheduling loop a number of times indicated by the loop count, the loop count corresponding to a number of scheduling loop executions sufficient to exercise the IHS for a predetermined amount of runtime.

7. The method of claim, further comprising:
fetching, by the IHS, an adjustment count value from an adjustment count table; and
applying, by the master control loop, the adjustment count value to the scheduling loop to correct timing of the scheduling loop when the adjustment count value indicates a need for such correction.

8. An information handling system (IHS), comprising:
a processor,
a memory, coupled to the processor, the memory being configured with a soaker tool that:
receives a selected utilization value;
fetches from a parameter table a particular utilization time and a particular wait time that correspond to the selected utilization value, the parameter table including an index of utilization values and respective utilization times and wait times;
executes a utilization loop of instructions that exercises the IHS according to the particular utilization time;
monitors for a dispatch interrupt during the execution of the utilization loop; and
waits the particular wait time after the IHS executes the utilization loop for the particular utilization time.

9. The IHS of claim 8, wherein the memory is further configured with a soaker tool that:
exits the utilization loop if while monitoring the IHS detects a dispatch interrupt during execution of the utilization loop and, in response to detecting a dispatch interrupt, reduces the utilization time by the portion of the utilization time already executed thus providing a remainder utilization time; and
re-enters the utilization loop of instructions to continue exercising the IHS according to the remainder utilization time.

10. The IHS of claim 9, wherein the memory is further configured with a soaker tool that:
schedules a number of utilization loops of instructions and respective wait times to consume an amount of time equal to a predetermined quantum time.

11. The IHS of claim 10, wherein the soaker tool includes a scheduling loop of instructions that schedules a number of utilization loops of instructions that provide the utilization times followed by respective wait times.

12. The IHS of claim 9, wherein the portion of the utilization time already executed is determined by the IHS determining the difference between a loop execution start time when the IHS starts to execute the utilization loop of instructions and a dispatch time when the IHS interrupts execution of the utilization loop of instructions.

13. The IHS of claim 11, wherein the soaker tool includes a master control loop that fetches from the parameter table a loop count corresponding to the utilization value, and executes the scheduling loop a number of times indicated by the loop count, the loop count corresponding to a number of scheduling loop executions sufficient to exercise the IHS for a predetermined amount of runtime.

14. The IHS of claim 13, wherein the master control loop is configured to:
fetch an adjustment count value from an adjustment count table;
execute a number of scheduling loops of instructions sufficient to implement the utilization value for a predetermined runtime; and
apply the adjustment count value to the scheduling loop to correct timing of the scheduling loop when the adjustment count value indicates a need for such correction.

15. An soaker tool computer program product, comprising:
a computer readable storage medium;
first program instructions that receives a selected utilization value;
second program instructions that fetch from a parameter table a particular utilization time and a particular wait time that correspond to the selected utilization value, the parameter table including an index of utilization values and respective utilization times and wait times;
third program instructions that execute a utilization loop of instructions that exercises the IHS according to the particular utilization time;
fourth program instructions that monitor for a dispatch interrupt during the execution of the utilization loop; and
fifth program instructions that wait the particular wait time after the IHS executes the utilization loop for the particular utilization time;
wherein the first, second, third, fourth, and fifth instructions are stored on the computer readable storage medium.

16. The soaker tool computer program product of claim 15, further comprising:
sixth program instructions that exit the utilization loop if while monitoring the IHS detects a dispatch interrupt during execution of the utilization loop and, in response to detecting a dispatch interrupt, reduce the utilization time by the portion of the utilization time already executed thus providing a remainder utilization time; and
seventh program instructions that re-enter the utilization loop of instructions to continue exercising the IHS according to the remainder utilization time.

17. The soaker tool computer program product of claim 16, further comprising eighth program instructions that schedule a number of utilization loops of instructions and respective wait times to consume an amount of time equal to a predetermined quantum time.

18. The soaker tool computer program product of claim 17, further comprising:
ninth program instructions that form a scheduling loop of instructions that schedules a number of utilization loops of instructions that provide the utilization times followed by respective wait times; and
tenth program instructions that form a master control loop that fetches from the parameter table a loop count corresponding to the utilization value, and executes the scheduling loop a number of times indicated by the loop count, the loop count corresponding to a number of scheduling loop executions sufficient to exercise the IHS for a predetermined amount of runtime.

19. The soaker tool computer program product of claim 18, further comprising eleventh program instructions that fetch an adjustment count value from an adjustment count table.

20. The soaker tool computer program product of claim 19, further comprising:
twelfth program instructions that execute a number of scheduling loops of instructions sufficient to implement the utilization value for a predetermined runtime; and
thirteenth program instructions that apply the adjustment count value to the scheduling loop to correct the timing of the scheduling loop when the adjustment count value indicates a need for such correction.
